(19) United States
(12) Patent Application Publication
(10) Pub. No.: US 2026/0170226 A1
(43) Pub. Date: Jun. 18, 2026

(54) METHOD FOR DETERMINING QUANTITY CORRESPONDING TO PERIPHERAL MODULES FOR REDUCING GATE COUNT, METHOD FOR REDUCING POWER CONSUMPTION AND SYSTEM ON CHIP

(71) Applicant: NUVOTON TECHNOLOGY CORPORATION, HSINCHU CITY (TW)

(72) Inventor: Chih-Ming CHEN, zhubei City (TW)

(21) Appl. No.: 19/399,112

(22) Filed: Nov. 24, 2025

(30) Foreign Application Priority Data
Dec. 16, 2024 (TW) 113148853

(51) Int. Cl. G06F 30/398; G06F 115/02

(52) U.S. Cl. CPC G06F 30/398; G06F 2115/02

(57) ABSTRACT

A method for determining a quantity corresponding to peripheral modules for reducing gate count, executed in a development stage of a SoC, and the method has steps: (A) selecting an estimated quantity corresponding to first peripheral modules; (B) dispose the first peripheral module in the SoC based on the estimated quantity corresponding to first peripheral modules; (C) obtaining an activation status and a peripheral setting parameter and performance parameter set of each of the first peripheral modules; (D) using a trained machine learning model to calculate a first processing timing of data transmission of each of the first peripheral modules based on the activation status and the peripheral setting parameter and performance parameter set of each of the first peripheral modules; (E) using an inference unit to determine whether to reduce the estimated quantity based on the first processing timing of data transmission of each of the first peripheral modules.

### CROSS-REFERENCE TO RELATED APPLICATION

This application claims the benefit of Taiwan Patent Application No. 113148853, filed on Dec. 16, 2024, in the Taiwan Intellectual Property Office, the disclosure of which is incorporated herein in its entirety by reference.

### BACKGROUND OF THE INVENTION

### 1. Field of the Invention

The present invention relates to a method for determining a quantity corresponding to peripheral modules for reducing a gate count, a method for reducing power consumption, and a SoC, and more particularly the present invention relates to a method for using a machine learning module to evaluate whether to reduce a gate count, a method for using a machine learning module to reduce power consumption, and a SoC using the aforementioned methods.

### 2. Description of the Related Art

During the development and application stages, a System on Chip (SoC) evaluates the quantity corresponding to various peripheral modules and the allocation of Multi-Function Pins (MFP) based on the application of the system. For example, the evaluation includes operations of planning the quantity corresponding to Quad Serial Peripheral Interface (QSPI) modules, Universal Asynchronous Receiver/Transmitter (UART) modules, inter-Integrated Circuit (I2C) modules, and Controller Area Network Flexible Data-Rate (CAN FD) modules in the SoC and even planning the quantity corresponding to Direct Memory Access channel (DMA channel) connected to the peripheral module in the SoC.

In prior art practice, the quantity corresponding to the peripheral modules and the quantity corresponding to the DMA channel are determined based on the client's possible applications and previous project experience in the product development stage. In some cases, the maximum quantity corresponding to the peripheral modules and the maximum quantity corresponding to the direct memory access channel are selected to avoid not being able to meet the client's possible applications, but it results in a significant increase in the gate count of the SoC. In other words, the prior art practice not only increases the area and cost of the SoC but also may led to higher power consumption of the SoC, which completely fails to comply with the current trend of electronic products being light, thin, short and small, and the trend of energy-saving, carbon reduction and sustainable environmental protection.

### SUMMARY OF THE INVENTION

According to above description, one of the objectives of the present invention is to use an internal machine learning module added in the development stage of the SoC to obtain, in a possible application, an activation status and a peripheral setting parameter and performance parameter set of each of peripheral modules of the same type based on an internal timing clock as one of the parameters on a time axis, and calculate the processing timing of data transmission of each of the peripheral modules of the same type to determine the quantity corresponding to the peripheral modules of the same type, based on the processing timing of data transmission of each of the peripheral modules of the same type, thereby reducing the gate count of the SoC. In addition, another objective of the present invention is to use an internally added machine learning module to determine, in a usage stage of the SoC, whether to reduce at least one of an advanced high-performance bus clock frequency, an advanced peripheral bus clock frequency, and a peripheral bus clock frequency, and/or determine whether to turn off one of the peripheral modules and use another one of the peripheral modules for data transmission, based on the processing timing of data transmission of each peripheral module of the same type, thereby reducing the power consumption of the SoC during the usage stage.

To achieve one of the objectives of the present invention, an embodiment of the present invention provides a method for determining a quantity corresponding to peripheral modules for reducing gate count, and the method is executed in a development stage of a system on chip (SoC) and includes steps of: (A) selecting an estimated quantity corresponding to first peripheral modules; (B) disposing the first peripheral modules in the SoC based on the estimated quantity; (C) obtaining an activation status and a peripheral setting parameter and performance parameter set of each of the first peripheral modules; (D) using a trained machine learning model to calculate a first processing timing of data transmission of each of the first peripheral modules based on the activation status and the peripheral setting parameter and performance parameter set of each of the first peripheral modules; (E) using an inference unit to determine whether to reduce the estimated quantity corresponding to first peripheral modules based on the first processing timing of data transmission of each of the first peripheral modules.

To achieve one of the objectives of the present invention, an embodiment of the present invention provides a method for reducing power consumption, and the method is executed in an SoC and comprises steps of: obtaining an activation status and a peripheral setting parameter and performance parameter set of each of first peripheral modules of the SoC; using a trained machine learning model to calculate a first processing timing of data transmission of each of the first peripheral modules based on the activation status and the peripheral setting parameter and performance parameter set of each of the first peripheral modules; based on the first processing timing of data transmission of each of the first peripheral modules, using an inference unit to determine whether to reduce at least one of an advanced high-performance bus clock frequency, an advanced peripheral bus clock frequency and a peripheral bus clock frequency, and/or determining whether to turn off one of the first peripheral modules and use another one of the first peripheral modules for data transmission.

To achieve one of the objectives of the present invention, an embodiment of the present invention provides a System on Chip (SoC) including a SoC main body and a machine learning module. The machine learning module is electrically connected to the SoC main body, wherein the machine learning module, in a development stage of the SoC, performs operations of: (A) selecting an estimated quantity corresponding to first peripheral modules; (B) disposing the first peripheral modules in the SoC based on the estimated quantity corresponding to first peripheral modules; (C) obtaining an activation status and a peripheral setting parameter and performance parameter set of each of the first peripheral modules; (D) using a trained machine learning model to calculate a first processing timing of data transmission of each of the first peripheral modules based on the activation status and the peripheral setting parameter and performance parameter set of each of the first peripheral modules; (E) using an inference unit to determine whether to reduce the estimated quantity corresponding to first peripheral modules based on the first processing timing of data transmission of each of the first peripheral modules.

To achieve one of the objectives of the present invention, an embodiment of the present invention provides a system on chip (SoC) including a SoC main body, and a machine learning module electrically connected to the SoC main body. In an usage stage of the SoC, the machine learning module performs steps of: obtaining an activation status and a peripheral setting parameter and performance parameter set of each of first peripheral modules of the SoC; using a trained machine learning model to calculate a first processing timing of data transmission of each of the first peripheral modules based on the activation status and the peripheral setting parameter and performance parameter set of each of the first peripheral modules; based on the first processing timing of data transmission of each of the first peripheral modules, using an inference unit to determine whether to reduce at least one of an advanced high-performance bus clock frequency, an advanced peripheral bus clock frequency and a peripheral bus clock frequency, and/or determine whether to turn off one of the first peripheral modules and use another one of the first peripheral modules for data transmission.

In summary, compared with the prior art, the method for determining a quantity corresponding to peripheral modules for reducing gate count, the method for reducing power consumption, and the SoC provided by the present invention can determine the quantity corresponding to peripheral modules of each type in a development stage of the SoC, thereby reducing the gate count of the SoC. Furthermore, in the usage stage of the SoC, the power consumption of the SoC can be reduced by adjusting the clock frequency of different types of buses and controlling the switching of the peripheral module.

### BRIEF DESCRIPTION OF THE DRAWINGS

The structure, operating principle and effects of the present invention will be described in detail by way of various embodiments which are illustrated in the accompanying drawings.

FIG. 1 is a block diagram of a SoC, according to an embodiment of the present invention.

FIG. 2 is a block diagram of a quad serial peripheral interface module, according to an embodiment of the present invention.

FIG. 3 is a schematic diagram of a signal waveform of a quad serial peripheral interface module according to an embodiment of the present invention.

FIG. 4 is a schematic diagram of another signal waveform of a quad serial peripheral interface module according to an embodiment of the present invention.

FIG. 5 is a schematic flowchart of a part of a method for determining a quantity corresponding to peripheral modules for reducing a gate count, according to an embodiment of the present invention.

FIG. 6 is a schematic flowchart of another part of a method for determining a quantity corresponding to peripheral modules for reducing a gate count, according to an embodiment of the present invention.

FIG. 7 is a schematic flowchart of yet another part of a method for determining a quantity corresponding to peripheral modules for reducing a gate count, according to an embodiment of the present invention.

FIG. 8 is a schematic flowchart of a method for reducing power consumption according to an embodiment of the present invention.

FIG. 9 is a schematic flowchart of another embodiment of a method for reducing power consumption according to the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims.

These embodiments are provided so that this disclosure is thorough and complete, and fully conveys the inventive concept to those skilled in the art. Regarding the drawings, the relative proportions, and ratios of elements in the drawings may be exaggerated or diminished in size for the sake of clarity and convenience. Such arbitrary proportions are only illustrative and not limiting in any way. The same reference numbers are used in the drawings and descriptions to refer to the same or like parts. As used herein, the singular forms “a”, “an” and “the” are intended to include the plural forms as well, unless the context clearly indicates otherwise. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the words “comprise” and “include,” and variations such as “comprises,” “comprising,” “includes,” or “including,” will be acknowledged to imply the inclusion of stated elements but not the exclusion of any other elements.

The embodiments of the present invention will be described in detail below with reference to the drawings, but it should be noted that the following implementation details are not intended to limit the scope of the claims of the present invention, and are only for the convenience of understanding by those with ordinary skill in the art. In addition, the sizes of the components in the drawings, the intensity levels of the signal waveforms and/or the order of the steps, etc., are schematic without special limitations, and are not intended to limit the present invention.

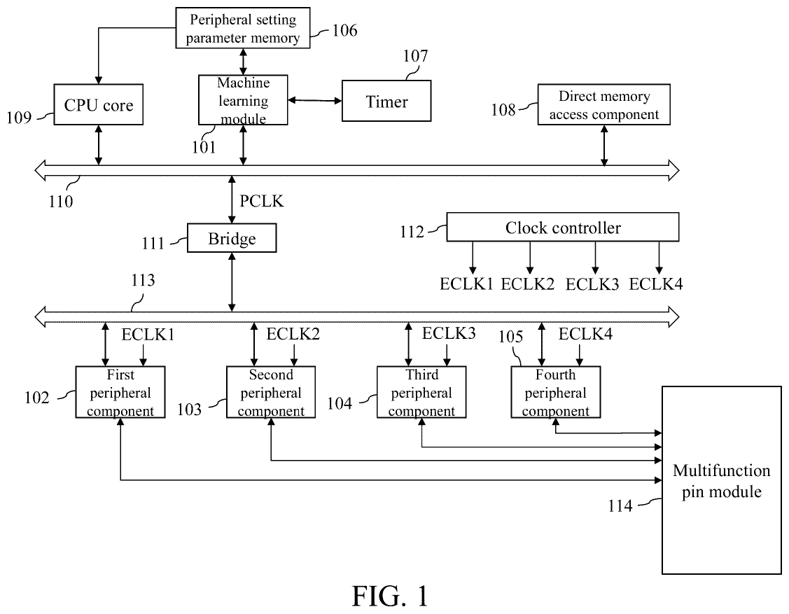

Please refer to FIG. 1. FIG. 1 is a block diagram of a System on Chip (SoC) according to an embodiment of the present invention. The SoC includes a SoC main body and a machine learning module 101, the machine learning module 101 is electrically connected to the SoC main body. In this embodiment, the SoC main body includes a first peripheral component 102, a second peripheral component 103, a third peripheral component 104, a fourth peripheral component 105, a peripheral setting parameter memory 106, a timer 107, a direct memory access component 108, a CPU core 109, a system bus 110, a bridge 111, a clock controller 112, a peripheral bus 113, and a multifunction pin module 114.

The machine learning module 101 is electrically connected to the system bus 110, the timer 107, and the peripheral setting parameter memory 106. The CPU core 109 is electrically connected to the system bus 110 and the peripheral setting parameter memory 106. The direct memory access component 108 is electrically connected to the system bus 110. The bridge 111 is electrically connected to the system bus 110 and the peripheral bus 113. The first peripheral component 102, the second peripheral component 103, the third peripheral component 104 and the fourth peripheral component 105 are electrically connected to the clock controller 112, the peripheral bus 113 and the multifunction pin module 114. The direct memory access component 108 has a direct memory access device, and a quantity corresponding to the direct memory access device(s) is a quantity corresponding to the direct memory access channel(s). The first peripheral component 102, the second peripheral component 103, the third peripheral component 104 and the fourth peripheral component 105 have a first peripheral module, a second peripheral module, a third peripheral module and a fourth peripheral module, respectively, quantities corresponding to the first peripheral module, the second peripheral module, the third peripheral module and the fourth peripheral module can be a first peripheral module quantity, a second peripheral module quantity, a third peripheral module quantity and a fourth peripheral module quantity, respectively.

In addition, the first peripheral module, the second peripheral module, the third peripheral module and the fourth peripheral module are different types of peripheral modules. One of the first peripheral module, the second peripheral module, the third peripheral module and the fourth peripheral module can be one of a serial peripheral interface module, a dual serial peripheral interface module, a quad serial peripheral interface module, a universal asynchronous receiver transmitter module, an inter-integrated circuit interface module, an integrated interchip sound (12S) interface module, and a Controller Area Network Flexible Data-Rate module.

The peripheral setting parameter memory 106 stores peripheral setting parameters of various peripheral modules and provides the peripheral setting parameters of various peripheral modules to the machine learning module 101. The machine learning module 101 can also monitor the system bus 110 to obtain the performance parameters of various peripheral modules corresponding to the respective peripheral setting parameters, and obtain the activation statuses of various peripheral modules through the SoC application timing provided by the timer 107. The peripheral setting parameter and the corresponding performance parameters of each of the peripheral modules are formed as a peripheral setting parameter and performance parameter set corresponding to each of peripheral modules. Furthermore, the activation status of the peripheral module can be the module activation frequency of the peripheral module, the peripheral setting parameter and performance parameter set comprises a peripheral bus clock frequency, a bus data load, a data access clock frequency, an internal synchronous timing budget, an SoC function application period, a transmission bit length and a bit rate. The data access clock frequency is a direct memory access clock frequency or a CPU access clock frequency.

The bridge 111 uses a peripheral clock PCLK of peripheral bus clock frequency to perform data transmission with the system bus 110. The CPU core 109 uses a system clock of the advanced high-performance bus clock frequency to perform data transmission with the system bus 110. The clock controller 112 is used to generate the peripheral module clock used by each peripheral module, and the frequency of the peripheral module clock is the peripheral bus clock frequency. In this embodiment, the clock controller 112 generates a first peripheral module clock ECLK1, a second peripheral module clock ECLK2, a third peripheral module clock ECLK3 and a fourth peripheral module clock ECLK4 for the first peripheral module of the first peripheral component 102, the second peripheral module of the second peripheral component 103, the third peripheral module of the third peripheral component 104 and the fourth peripheral module of the fourth peripheral component 105, respectively, as their operating clocks. The multifunction pin module 114 has a multifunction pin module register device and external pins. The multifunction pin module register device is electrically connected to the external pins to enable data transmission among various peripheral modules through the external pins.

The feature of the present invention is to additionally dispose the machine learning module 101 in the SoC. The machine learning module 101 executes a method for determining a quantity corresponding to peripheral modules for reducing a gate count in the development stage of the SoC to determine the quantities of various peripheral modules. In addition, the method for determining quantities corresponding to peripheral modules for reducing a gate count can determine the quantity corresponding to the direct memory access devices in the development stage of the SoC, that is, the quantity corresponding to the direct memory access devices can be an estimated quantity corresponding to direct memory access channels. In addition, the machine learning module 101 is used to execute a method for reducing power consumption, and the method reduces power consumption by switching the usage statuses of the peripheral modules or by adjusting various clock frequency. Furthermore, the machine learning module 101 includes a trained machine learning model and an inference unit. The machine learning model is used for predicting specific data based on the input data, and the inference unit performs related inference based on the predicted data.

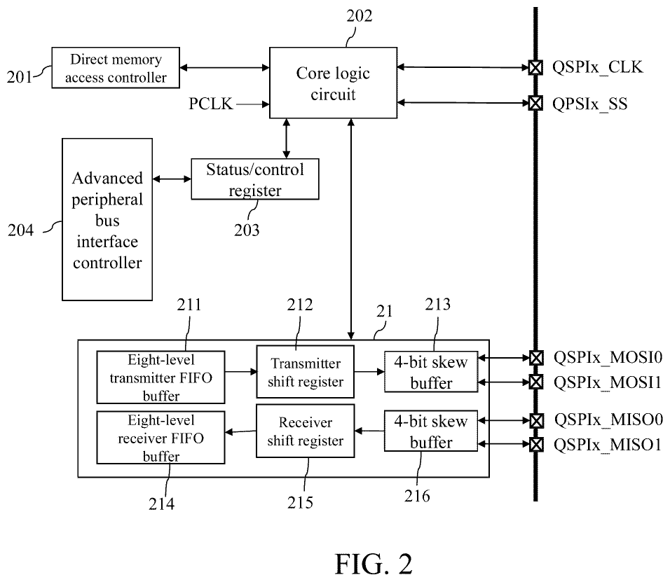

Please refer to FIG. 2. FIG. 2 is a block diagram of a quad serial peripheral interface module, according to an embodiment of the present invention. When the peripheral module is a quad serial peripheral interface module, the peripheral module includes a direct memory access controller 201, a core logic circuit 202, a status/control register 203, an advanced peripheral bus interface controller 204 and a data transmission module 21. The data transmission module 21 includes an eight-level transmitter FIFO buffer 211, a transmitter shift register 212, an eight-level receiver FIFO buffer 214, a receiver shift register 215, and 4-bit skew buffers 213 and 216. The FIFO buffer with 8 levels is just an example, and the actual design cannot be limited to 8 stages. The skew buffer with 4 bits is just an example, and the actual design cannot be limited to 4 bits.

The status/control register 203 is electrically connected to the advanced peripheral bus interface controller 204. The direct memory access controller 201 is electrically connected to the core logic circuit 202, the core logic circuit 202 receives a peripheral clock PCLK, is electrically connected to the status/control register 203 and the data transmission module 21, and is used for receiving and transmitting signals QPSIx_CLK and QPSIx_SS. The eight-level transmitter FIFO buffer 211 is electrically connected to the transmitter shift register 212, the transmitter shift register 212 is electrically connected to the 4-bit skew buffer 213, and the 4-bit skew buffer 213 is used for receiving and transmitting signals QPSIx_MOSI0, QPSIx_MOSI1. The eight-level receiver FIFO buffer 214 is electrically connected to the receiver shift register 215, the receiver shift register 215 is electrically connected to the 4-bit skew buffer 216, and the 4-bit skew buffer 216 is used for receiving and transmitting signals QPSIx_MISO0 and QPSIx_MISO1.

When performing data transmission, the peripheral module is not only based on parameters such as the amount of data transmitted and data transmission performance (for example, bit rate), but also based on the characteristics thereof. In other words, when the machine learning model predicts the processing timing of the data transmission of the peripheral module, the machine learning model also takes into account the characteristics of the peripheral module. In the example of FIG. 2, after the peripheral module is started, a synchronization control signal must be generated through the core logic circuit 202 to synchronously transmit the data to the transmitter shift register 212 and the 4-bit skew buffer 213 whether the data is written to the eight-level transmitter FIFO buffer 211 through the CPU core or the direct memory access device. In this example, at least five peripheral module clocks ECLK and two peripheral clocks PCLK are needed. In other words, after the first piece of data is written into the eight-level transmitter FIFO buffer 211, the machine learning model predicts the processing timing of the data transmission of the peripheral module.

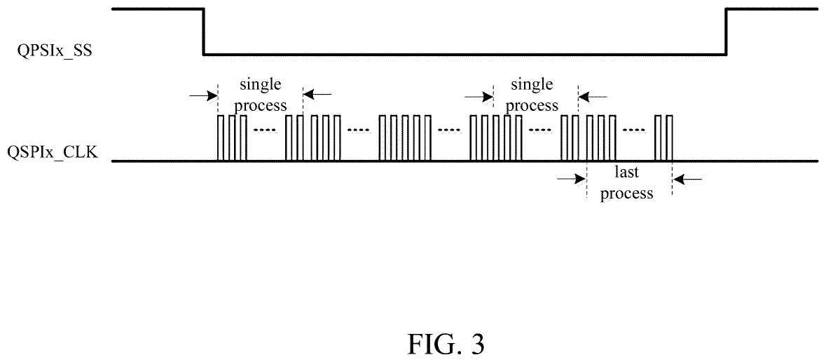

Please refer to FIG. 2 and FIG. 3. FIG. 3 is a schematic diagram of a signal waveform of a quad serial peripheral interface module according to an embodiment of the present invention. The signal QSPIx_SS is used to indicate the status in which the peripheral module is selected for use, that is, the peripheral module is started; the signal QPSIx_CLK indicates the working clock used by the peripheral module. The machine learning model is used to predict and estimate the processing timing of data transmission of the peripheral module during data transmission. In the case of FIG. 3, the timings of single processes and the last process constitute the processing timing of data transmission of the peripheral module.

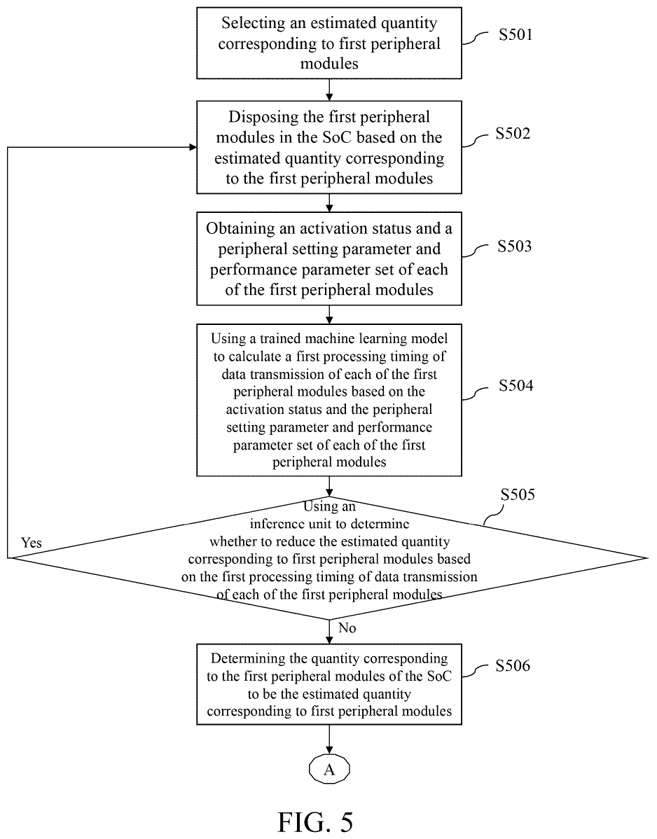

Please refer to FIG. 1 and FIG. 5. FIG. 5 is a schematic flowchart of a part of a method for determining a quantity corresponding to peripheral modules for reducing a gate count according to an embodiment of the present invention. The embodiment of FIG. 5 first determines a quantity corresponding to first peripheral modules, but the present invention is not limited thereto. The method for determining quantity corresponding to peripheral modules for reducing gate count of the present invention can first determine a quantity corresponding to peripheral modules of one type, and then determine the quantity corresponding to peripheral modules of another type, so that the quantities corresponding to peripheral modules of each type can be optimized.

The embodiment of FIG. 5 includes the following steps. In step S501, an estimated quantity corresponding to first peripheral modules is selected, for example, the estimated quantity corresponding to the first peripheral modules is selected as 3. In step S502, the first peripheral modules are disposed in the SoC based on the estimated quantity corresponding to the first peripheral modules, for example, three first peripheral component 102 are disposed in the SoC. In step S503, an activation status and a peripheral setting parameter and performance parameter set of each of the first peripheral modules are obtained. In step S504, a trained machine learning model is used to calculate a first processing timing of data transmission of each of the first peripheral modules based on the activation status and the peripheral setting parameter and performance parameter set of each of the first peripheral modules.

In step S505, an inference unit is used to determine whether to reduce the estimated quantity corresponding to first peripheral modules based on the first processing timing of data transmission of each of the first peripheral modules. When the inference unit determines to reduce the estimated quantity, for example, the estimated quantity can be reduced from 3 to 2, step S502 is performed. When the inference unit determines not to reduce the estimated quantity, step S502 is performed. In step S506, the quantity corresponding to the first peripheral modules of the SoC is determined to be the estimated quantity corresponding to first peripheral modules. For example, when the estimated quantity corresponding to the first peripheral modules is determined to be reduced from 3 to 2, steps S502 to S505 are executed again. In step S505, when it is determined not to reduce the estimated quantity corresponding to the first peripheral modules from 2 to 1, the quantity corresponding to the first peripheral modules of the SoC is finally determined to be 2. Furthermore, the way to determine whether to reduce the estimated quantity corresponding to the first peripheral modules based on the first processing timing of data transmission of each of the first peripheral modules is that when the first processing timings of the data transmission of any two of the first peripheral modules do not overlap with each other, it indicates that the estimated quantity corresponding to the first peripheral modules first peripheral modules can be reduced.

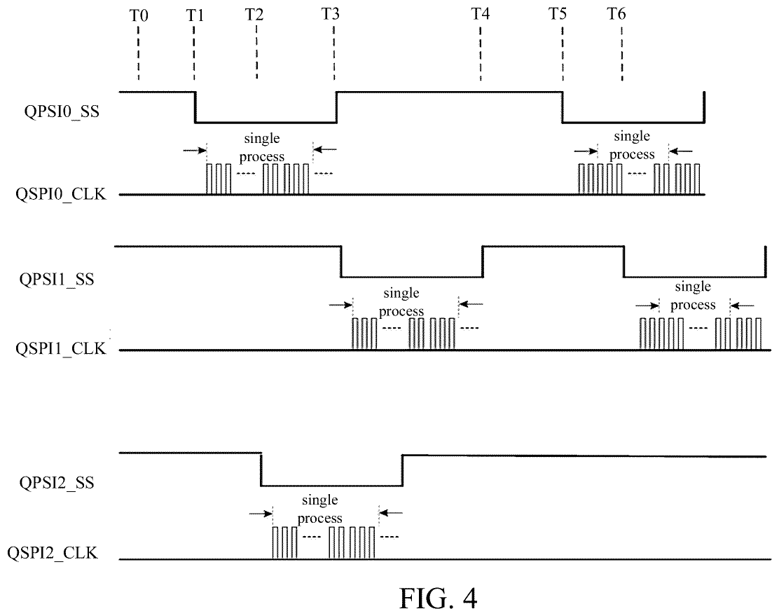

Please refer to FIG. 4. FIG. 4 is a schematic diagram of another signal waveform of a quad serial peripheral interface module according to an embodiment of the present invention. In FIG. 4, the first peripheral component is provided with three quad serial peripheral interface modules. The signals QSPI0_SS to QSPI2_SS represent the usage statuses of the three quad serial peripheral interface modules (that is, they respectively represent the activation statuses), and the signals QSPI0_CLK to QSPI2_CLK represent the working clocks used by the three quad serial peripheral interface modules. In FIG. 4, the processing timings of the three quad serial peripheral interface module for data transmission can be estimated and organized into Table 1.

TABLE 1

Time Point

| Number | T0 | T1 | T2 | T3 | T4 | T5 | T6 |
|---|---|---|---|---|---|---|---|
| QSPI0 | X | ◯ | ◯ | X | X | ◯ | ◯ |
| QPSI1 | X | X | X | ◯ | X | X | X |
| QPSI2 | X | X | ◯ | ◯ | X | X | X |

In Table 1, the three quad serial peripheral interface modules are given numbers QPSI0 to QPSI3, respectively. The “X” for the processing timing in the table indicates that the corresponding quad serial peripheral interface module is not pulled up at that time point, that is, the resource is occupied for data transmission. The “O” for the processing timing in the table indicates that the corresponding quad serial peripheral interface module is pulled up at that time point, that is, the resource is occupied for data transmission. It can be known from Table 1 that the processing timings of the quad serial peripheral interface module with number QPSI0 and the quad serial peripheral interface module with number QPSI1 do not overlap with each other, so the data transmission behavior performed by the quad serial peripheral interface module with number QPSI1 at time point T3 can be changed to be performed by the quad serial peripheral interface module with number QPSI0. Therefore, the inference unit infers that, in fact, three quad serial peripheral interface modules are not necessary, and only two quad serial peripheral interface modules are needed to complete the design of the SoC.

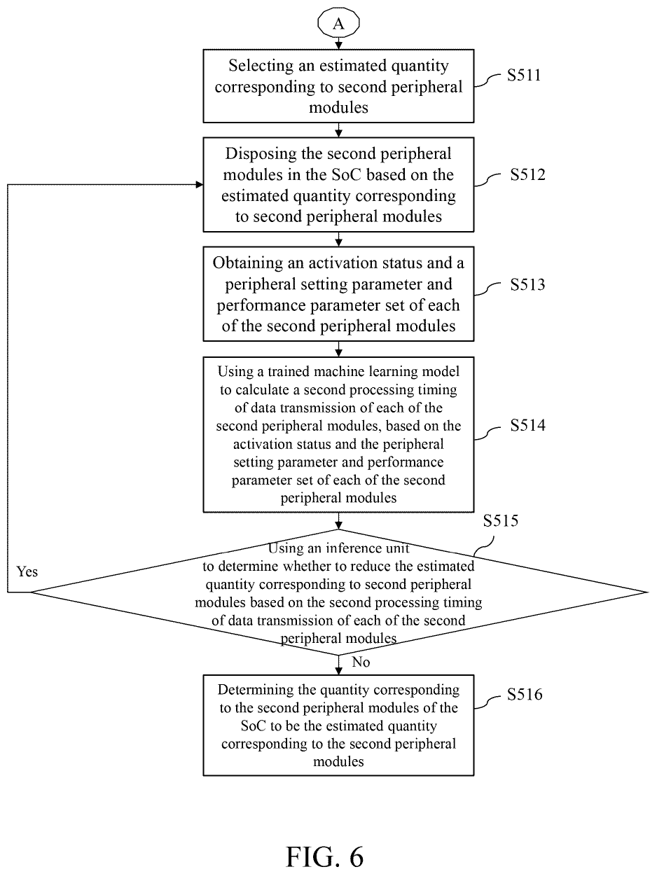

Please continue to refer to FIG. 1 and FIG. 6. FIG. 6 is a schematic flowchart of another part of a method for determining quantity corresponding to peripheral modules for reducing gate count according to an embodiment of the present invention. After it is determined how many first peripheral components 102 is needed, the quantity corresponding to the second peripheral components 103 is determined. In step S511, an estimated quantity corresponding to second peripheral modules is selected. Then, in step S512, the second peripheral modules are disposed in the SoC based on the estimated quantity corresponding to second peripheral modules. In step S513, an activation status and a peripheral setting parameter and performance parameter set of each of the second peripheral modules is obtained. Next, in step S514, a trained machine learning model is used to calculate a second processing timing of data transmission of each of the second peripheral modules, based on the activation status and the peripheral setting parameter and performance parameter set of each of the second peripheral modules.

Next, in step S515, an inference unit is used to determine whether to reduce the estimated quantity corresponding to second peripheral modules based on the second processing timing of data transmission of each of the second peripheral modules. If the inference unit determines to reduce the estimated quantity corresponding to the second peripheral modules, for example, the estimated quantity corresponding to the second peripheral modules can be reduced from 4 to 3, step S502 is performed. If the inference unit determines not to reduce the estimated quantity corresponding to the second peripheral modules, step S502 is performed. In step S516, the quantity corresponding to the second peripheral modules of the SoC is determined to be the estimated quantity corresponding to the second peripheral modules. For example, when the inference unit determines to reduce the estimated quantity corresponding to second peripheral modules from 4 to 3, steps S502 to S515 are executed again. When the inference unit determines that the estimated quantity corresponding to second peripheral modules cannot be reduced from 3 to 2 in step S515, the quantity corresponding to the second peripheral modules of the SoC is finally determined to be 3.

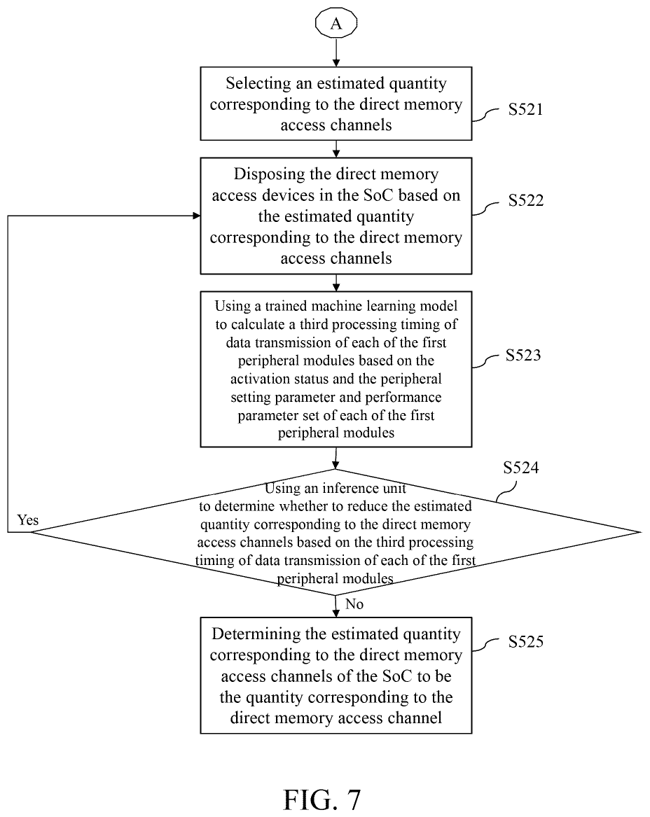

Please continue to refer to FIG. 1 and FIG. 7. FIG. 7 is a schematic flowchart of yet another part of a method for determining quantity corresponding to peripheral modules for reducing a gate count according to an embodiment of the present invention. After the quantity corresponding to first peripheral modules of the SoC is determined, the method for determining quantity corresponding to peripheral modules for reducing a gate count of the present invention can also be used to determine the quantity corresponding to the direct memory access channel (i.e., the quantity corresponding to the direct memory access device). First, in step S521, an estimated quantity corresponding to the direct memory access channels is selected. Next, in step S522, the direct memory access devices are disposed in the SoC based on the estimated quantity corresponding to the direct memory access channels. In step S523, a trained machine learning model is used to calculate a third processing timing of data transmission of each of the first peripheral modules based on the activation status and the peripheral setting parameter and performance parameter set of each of the first peripheral modules. Next, in step S524, an inference unit is used to determine whether to reduce the estimated quantity corresponding to the direct memory access channels based on the third processing timing of data transmission of each of the first peripheral modules. When the inference unit determines that the estimated quantity corresponding to the direct memory access channels can be decreased, step S522 is performed; otherwise, step S525 is performed. In step S525, the estimated quantity corresponding to the direct memory access channels of the SoC is determined to be the quantity corresponding to the direct memory access channel.

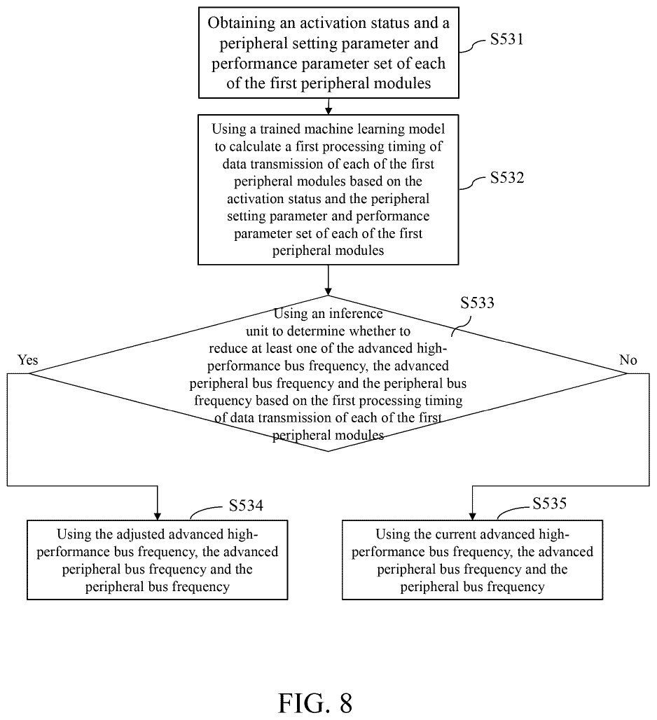

Please refer to FIG. 1 and FIG. 8. FIG. 8 is a schematic flowchart of a method for reducing power consumption according to an embodiment of the present invention. First, in step S531, an activation status and a peripheral setting parameter and performance parameter set of each of the first peripheral modules are obtained. Then, in step S532, a trained machine learning model is used to calculate a first processing timing of data transmission of each of the first peripheral modules based on the activation status and the peripheral setting parameter and performance parameter set of each of the first peripheral modules. Next, in step S533, an inference unit is used to determine whether to reduce at least one of the advanced high-performance bus frequency, the advanced peripheral bus frequency and the peripheral bus frequency based on the first processing timing of data transmission of each of the first peripheral modules. When the inference unit determines to reduce at least one of the advanced high-performance bus frequency, the advanced peripheral bus frequency and the peripheral bus frequency, step S534 is performed; otherwise, step S535 is performed. In step S534, the adjusted advanced high-performance bus frequency, the advanced peripheral bus frequency and the peripheral bus frequency are used in the system. In step S535, the current advanced high-performance bus frequency, the advanced peripheral bus frequency and the peripheral bus frequency are used in the system.

For example, please refer to FIG. 4 again. As shown in FIG. 4, the quad serial peripheral interface module with number QPSI1 only performs data transmission at time point T3, so that the inference unit can determine that at least one of the advanced high-performance bus frequency, the advanced peripheral bus frequency and the peripheral bus frequency can be reduced, at time point T3. At time point T1, the advanced high-performance bus frequency, the advanced peripheral bus frequency and the peripheral bus frequency are 200 MHz, 100 MHz and 100 MHz, respectively, and the power consumption current corresponding to the overall power consumption is 2 mA. Because it is determined at time point T3 that at least one of the advanced high-performance bus frequency, the advanced peripheral bus frequency and the peripheral bus frequency can be reduced, so the advanced high-performance bus frequency, the advanced peripheral bus frequency and the peripheral bus frequency are adjusted to 100 MHz, 100 MHz and 50 MHz at time point T3, respectively, and this adjustment can satisfy the operation of the system, while the power consumption current corresponding to the overall power consumption is reduced from 2 mA to 1.5 mA.

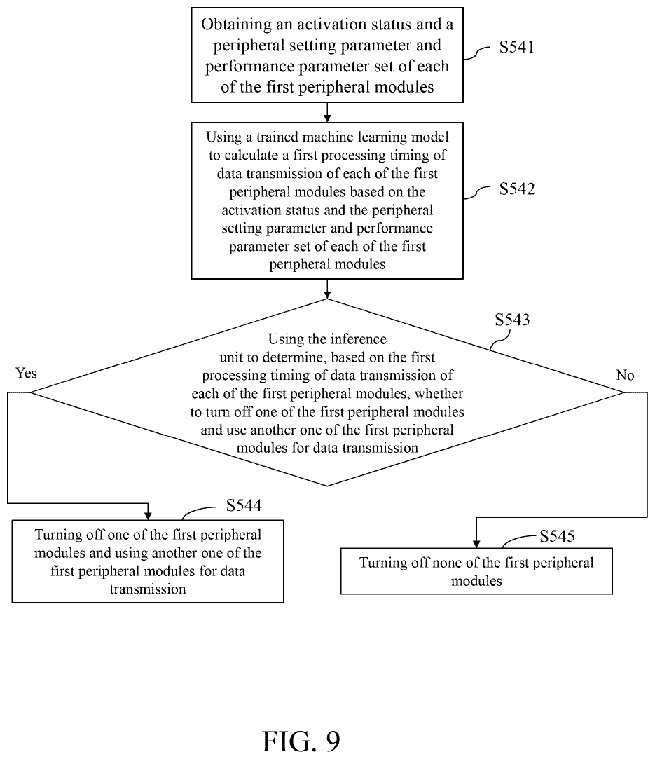

Please refer to FIG. 1 and FIG. 9. FIG. 9 is a schematic flowchart of another embodiment of a method for reducing power consumption according to the present invention. In addition to reduce at least one of the advanced high-performance bus frequency, the advanced peripheral bus frequency and the peripheral bus frequency, another way to reduce power consumption is to turn off one of the peripheral modules, and the data transmission that needs to be performed by the peripheral module turned off is performed by another of the peripheral modules. In step S541, an activation status and a peripheral setting parameter and performance parameter set of each of the first peripheral modules are obtained. In step S542, a trained machine learning model is used to calculate a first processing timing of data transmission of each of the first peripheral modules based on the activation status and the peripheral setting parameter and performance parameter set of each of the first peripheral modules. Next, in step S543, the inference unit is used to determine, based on the first processing timing of data transmission of each of the first peripheral modules, whether to turn off one of the first peripheral modules and use another one of the first peripheral modules for data transmission. When it is determined that another one of the first peripheral modules can be used for data transmission, step S544 is performed; otherwise, step S545 is performed. In step S544, one of the first peripheral modules is turned off and another one of the first peripheral modules is used for data transmission. In step S545, none of the first peripheral modules is turned off.

Please refer to FIG. 4 again. As shown in FIG. 4, the quad serial peripheral interface module with number QPSI1 only performs data transmission at time point T3, and the quad serial peripheral interface module with number QPSI0 does not perform data transmission at time point T3, so the inference unit can determine that the quad serial peripheral interface module with number QPSI1 is to be turned off, and the data transmission is instead performed by the quad serial peripheral interface module with number QPSI0, thereby reducing power consumption.

In summary, the method for determining the quantity corresponding to peripheral modules for reducing the gate count, the method for reducing power consumption, and the SoC provided by the present invention have the following characteristics: (1), the machine learning module is used to evaluate whether to reduce the quantity corresponding to the peripheral modules, thereby reducing the gate count of the SoC to decrease the circuit area and manufacturing cost of the SoC, and increase market competitiveness of the SoC; (2), the machine learning module is used to evaluate the quantity corresponding to the direct memory access channels required by the SoC, thereby reducing the gate count of the SoC; (3), the machine learning module is used to adjust the advanced high-performance bus clock frequency, the advanced peripheral bus clock frequency and the peripheral bus clock frequency in different timing, thereby improving the transmission performance and power consumption of the system; (4), the machine learning module can be used to turn off one of the peripheral module at different timings and use another peripheral module to perform data transmission instead, thereby improving the power consumption of the system.

The present invention is only disclosed herein in a preferred embodiment, but it should be understood by those skilled in the art that the above embodiments are only for describing the present invention, and are not intended to limit the scope of the patent rights claimed by the present invention. All changes or substitutions that are equivalent to or equivalent to the above embodiments should be interpreted as being covered by the spirit or scope of the present invention. Therefore, the scope of protection of the present invention should be based on what is defined by the following claims.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. A method for determining quantity corresponding to peripheral modules for reducing a gate count, executed in a development stage of a system on chip (SoC), and the method comprising:
(A) selecting an estimated quantity corresponding to first peripheral modules;
(B) disposing the first peripheral modules in the SoC based on the estimated quantity corresponding to the first peripheral modules;
(C) obtaining an activation status and a peripheral setting parameter and performance parameter set of each of the first peripheral modules;
(D) using a trained machine learning model to calculate a first processing timing of data transmission of each of the first peripheral modules based on the activation status and the peripheral setting parameter and performance parameter set of each of the first peripheral modules; and
(E) using an inference unit to determine whether to reduce the estimated quantity corresponding to the first peripheral modules based on the first processing timing of data transmission of each of the first peripheral modules.

2. The method according to claim 1, after the step of determining the quantity corresponding to the first peripheral modules of the SoC, further comprising:
selecting an estimated quantity corresponding to second peripheral modules;
disposing the second peripheral modules in the SoC based on the estimated quantity corresponding to the second peripheral modules;
obtaining an activation status and a peripheral setting parameter and performance parameter set of each of the second peripheral modules;
using the trained machine learning model to calculate a second processing timing of data transmission of each of the second peripheral modules based on the activation status and the peripheral setting parameter and performance parameter set of each of the second peripheral modules;
using the inference unit to determine whether to reduce the estimated quantity corresponding to the second peripheral modules based on the second processing timing of data transmission of each of the second peripheral modules.

3. The method according to claim 2, wherein one of the first peripheral modules and the second peripheral modules is selected from a serial peripheral interface module, a dual serial peripheral interface module, a quad serial peripheral interface module, a universal asynchronous receiver transmitter module, an inter-integrated circuit interface module, an integrated interchip sound interface module and a Controller Area Network Flexible Data-Rate module (CAN FD).

4. A method for reducing power consumption, executed in a system on chip (SoC), and the method comprising
obtaining an activation status and a peripheral setting parameter and performance parameter set of each of first peripheral modules of the SoC;
using a trained machine learning model to calculate a first processing timing of data transmission of each of the first peripheral modules based on the activation status and the peripheral setting parameter and performance parameter set of each of the first peripheral modules;
based on the first processing timing of data transmission of each of the first peripheral modules, using an inference unit to determine whether to reduce at least one of an advanced high-performance bus clock frequency, an advanced peripheral bus clock frequency and a peripheral bus clock frequency, and/or determining whether to turn off one of the first peripheral modules and use another one of the first peripheral modules for data transmission.

5. A system on chip (SoC), comprising:
a SoC main body;
a machine learning module, electrically connected to the SoC main body, wherein the machine learning module, in a development stage of the SoC, performs:
(A) selecting an estimated quantity corresponding to first peripheral modules;
(B) disposing the first peripheral modules in the SoC based on the estimated quantity corresponding to the first peripheral modules;
(C) obtaining an activation status and a peripheral setting parameter and performance parameter set of each of the first peripheral modules;
(D) using a trained machine learning model to calculate a first processing timing of data transmission of each of the first peripheral modules based on the activation status and the peripheral setting parameter and performance parameter set of each of the first peripheral modules;
(E) using an inference unit to determine whether to reduce the estimated quantity corresponding to the first peripheral modules based on the first processing timing of data transmission of each of the first peripheral modules.

6. The system on chip according to claim 5, wherein when it is determined to decrease the estimated quantity corresponding to the first peripheral modules, the estimated quantity corresponding to first peripheral modules is decreased, and the machine learning module repeats performing steps (B) to (E).

7. The system on chip according to claim 5, wherein when it is determined that the estimated quantity corresponding to first peripheral modules is not determined, a quantity corresponding to the first peripheral modules of the SoC is determined to be the estimated quantity corresponding to the first peripheral modules.

8. The system on chip according to claim 5, wherein the activation status of the first peripheral module is a module activation frequency of the first peripheral module, the peripheral setting parameter and performance parameter set comprises a peripheral bus clock frequency, a bus data load, a data access clock frequency, an internal synchronous timing budget, an SoC function application period, a transmission bit length and a bit rate, and the data access clock frequency is a direct memory access clock frequency or a CPU access clock frequency.

9. The SoC according to claim 5, wherein after the quantity corresponding to the first peripheral modules of the SoC is determined, the machine learning module, in the development stage of the SoC, performs:
selecting an estimated quantity corresponding to second peripheral modules;
disposing the second peripheral modules in the SoC based on the estimated quantity corresponding to the second peripheral modules;
obtaining an activation status and a peripheral setting parameter and performance parameter set of each of the second peripheral modules;
using a trained machine learning model to calculate a second processing timing of data transmission of each of the second peripheral modules based on the activation status and the peripheral setting parameter and performance parameter set of each of the second peripheral modules; and
using an inference unit to determine whether to reduce the estimated quantity corresponding to second peripheral modules based on the second processing timing of data transmission of each of the second peripheral modules.

10. The SoC according to claim 5, wherein after determining the quantity corresponding to the first peripheral modules of the SoC, the machine learning module, in the development stage of the SoC, performs:
selecting an estimated quantity corresponding to direct memory access channels;
disposing the direct memory access devices in the SoC based on the estimated quantity corresponding to the direct memory access channels, wherein the estimated quantity of the direct memory access devices are electrically connected to each of the first peripheral modules;
using a trained machine learning model to calculate a third processing timing of data transmission of each of the first peripheral modules based on the activation status and the peripheral setting parameter and performance parameter set of each of the first peripheral modules; and
using an inference unit to determine whether to reduce the estimated quantity corresponding to direct memory access channels based on the third processing timing of data transmission of each of the first peripheral modules.
